(19) United States
(12) Patent Application Publication
(10) Pub. No.: US 2005/0229796 A1
(43) Pub. Date: Oct. 20, 2005

(54) Depositing system and method of depositing material

(75) Inventor: Alan G. Miller, South Easton, MA (US)

Correspondence Address: WILMER CUTLER PICKERING HALE AND DORR LLP, 60 STATE STREET, BOSTON, MA, 02109, US

(73) Assignee: Risco USA Corporation, South Easton, MA (US)

(21) Appl. No.: 11/106,052

(22) Filed: Apr. 14, 2005

Related U.S. Application Data
(60) Provisional application No. 60/563,180, filed on Apr. 16, 2004.

(51) Int. Cl. A23N 1/00

(52) U.S. Cl. 99/537

(57) ABSTRACT

A depositing system includes one or more flaps adapted to move between a closed position in which the one or more flaps is arranged to receive a portion of material to be deposited and an open position in which the one or more flaps permits the portion of material to be deposited to fall from the one or more flaps, a conveyor, a sensor adapted to generate a signal upon identification of a target on the conveyor, and a controller arranged to move the one or more flaps from the closed to the open position in response to the signal so that a portion of material to be deposited drops onto the conveyor with a desired spatial relationship to the target on the conveyor. A method for depositing material is also disclosed.

### CROSS-REFERENCE TO RELATED APPLICATION

This application claims priority from provisional Ser. No. 60/563,180 filed Apr. 16, 2004, which is incorporated herein by reference.

### BACKGROUND AND SUMMARY

The present invention relates to a depositing system and, more particularly, to a depositing system adapted to deposit material as a function of a location of a target.

Typical assembly lines such as those used in making food items such as egg rolls and burritos involve a portioner, e.g., an apparatus adapted to deliver portions of food in consistent sizes and shapes such as an extruder with a guillotine knife arrangement at an outlet of the extruder for cutting an extruded product into portions of desired lengths. The cut extruded portion falls onto a set of depositing flaps, often referred to as “bomb doors,” which are operated by the same actuating device that operates the guillotine knife to open at the end of travel of the guillotine knife. From the depositing flaps, the portion falls onto a designated target such as an egg roll wrapper, a tortilla, or a tray that is conveyed underneath the depositing flaps, such as on a conveyor belt.

While conventional assembly line techniques produce acceptable products under normal circumstances and delivery of the portions and movement of the targets is properly synchronized, substantial waste occurs when portion delivery and target movement are not properly synchronized. In addition, the actuating device, such as a pneumatic cylinder, must move quickly in order to get a clean cut on the extruded product. As a consequence, the depositing flaps are also moved quickly and tend to be quite noisy.

In accordance with one aspect of the present invention, a depositing system includes one or more flaps adapted to move between a closed position in which the one or more flaps is arranged to receive a portion of material to be deposited and an open position in which the one or more flaps permits the portion of material to be deposited to fall from the one or more flaps, a conveyor, a sensor adapted to generate a signal upon identification of a target on the conveyor, and a controller arranged to move the one or more flaps from the closed to the open position in response to the signal so that a portion of material to be deposited drops onto the conveyor with a desired spatial relationship to the target on the conveyor.

In accordance with another aspect of the present invention, a method for depositing material includes sensing a position of a target on a conveyor with a sensor and, in response to a signal from the sensor, moving one or more flaps from a closed position in which the one or more flaps is arranged to receive a portion of material to be deposited to an open position in which the one or more flaps permits the portion of material to be deposited to fall from the one or more flaps so that the portion of material to be deposited drops onto the conveyor with a desired spatial relationship to the target on the conveyor.

In accordance with still another aspect of the present invention, an assembly line includes a conveyor for conveying targets, a sensor adapted to generate a signal upon sensing a location of a target on the conveyor, a door above the conveyor, the door being movable between a closed position and an open position, and a controller arranged to open the door in response to the signal from the sensor.

### BRIEF DESCRIPTION OF THE DRAWINGS

The features and advantages of the present invention are well understood by reading the following detailed description in conjunction with the drawings in which like numerals indicate similar elements and in which:

FIG. 1 is a schematic, perspective view of a depositing system with portion delivery flaps in a closed position according to an embodiment of the present invention; and

FIG. 2 is a schematic, perspective view of a depositing system with portion delivery flaps in an open position according to an embodiment of the present invention.

### DETAILED DESCRIPTION

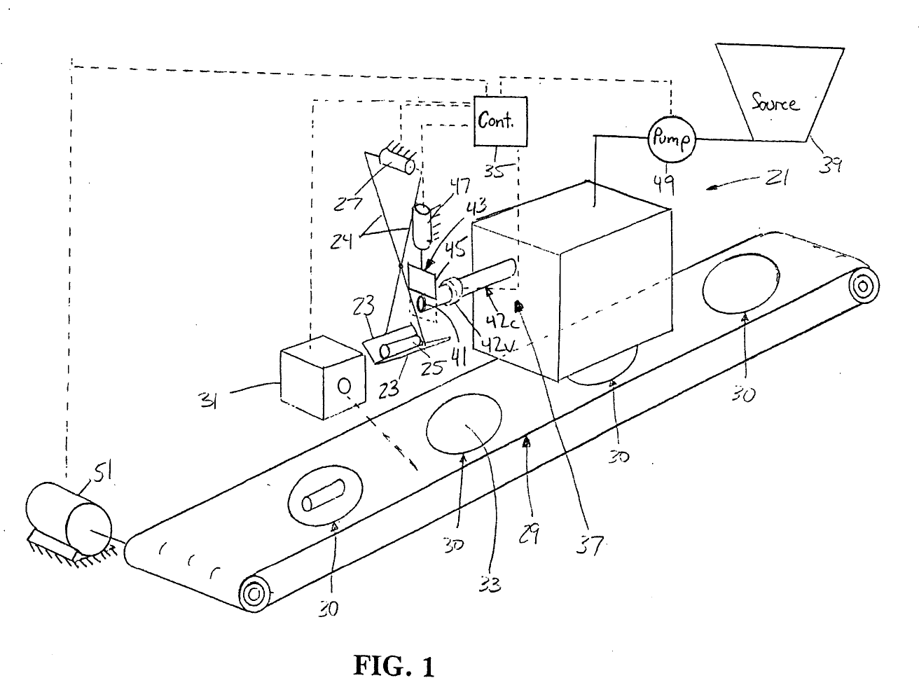

A depositing system 21 according to an embodiment of the present invention is shown in FIG. 1. The depositing system 21 will be described in connection with an assembly line for assembling food products but it will be appreciated that the depositing system has applications in other areas not necessarily involving food.

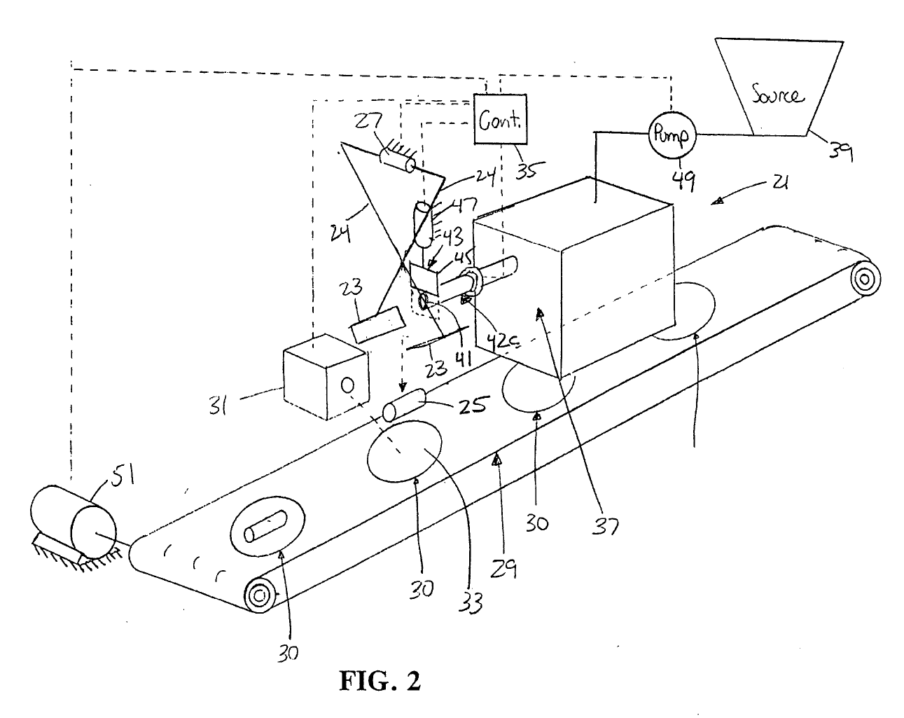

The depositing system 21 preferably has one or more doors or flaps 23 adapted to move between a closed position (FIG. 1) in which the one or more flaps is arranged to receive a portion 25 of material to be deposited and an open position (FIG. 2) in which the one or more flaps permits the portion of material to be deposited to fall from the one or more flaps. The one or more flaps 23 are preferably in the form of a pair of depositing flaps of the “bomb door” type that, when closed, define a substantially “V”-shape in which a portion 25 is received. An actuator 27, such as a servo actuator, opens and closes the flaps 23. The actuator 27 is any suitable type of actuator such as a pneumatic or hydraulic actuator that separates arms 24 extending from the flaps 23 in a scissor-like fashion.

The depositing system 21 includes a conveyor 29, such as a belt-type conveyor, that extends beneath the flaps 23. The conveyor 29 is preferably used to convey articles 30 intended to receive food portions 25, such as egg roll wrappers, tortillas, and plastic and paper trays.

A sensor 31 is adapted to generate a signal upon identification of a target 33 upon which a food portion 25 is intended to be deposited, such as an article 30 on the conveyor 29. The target 33 need not, however, be separate from the conveyor 29 and may, for example, be a particular point on the conveyor onto which it is desired to deposit a food portion 25. The sensor 31 is preferably a sensor of the “electric eye” type that optically senses the location of the target but may be any suitable sensor, such as a mechanical switch-type sensor.

A controller 35 is arranged to move the one or more flaps 23 from the closed to the open position in response to the signal from the sensor so that a portion 25 of material to be deposited drops onto the conveyor 31 with a desired spatial relationship to the target 33 on the conveyor. In the context of a depositing system used to deposit food portions on objects, of course, the desired spatial relationship of the dropped portion 25 and the target 33 is that the portion falls on top of the target, although there may be situations in which it will be desired to place a portion remote from a target 33.

The depositing system 21 preferably includes some form of delivery apparatus 37 such as an extruder which is preferably connected to a source of supply 39 of material for forming the portions 25, such as a hopper for grinding food and delivering ground food to an extrusion outlet or nozzle 41. At the outlet 41, a movable blade arrangement 43, e.g., a guillotine-type blade, is preferably provided for cutting material to be deposited into portions of a desired size.

The blade arrangement 43 preferably includes a blade 45 and an actuator 47 such as a pneumatic actuator adapted to move the blade quickly enough and with enough force to cut material being extruded through the outlet 41. The actuator 47 can cause the blade 45 to execute a cutting operation at predetermined time intervals, as a function of an amount of material to exit the outlet, or on some other suitable basis. The movable blade arrangement 43 is preferably operated by a different actuating device 47 than the actuator 27 that operates the one or more flaps 23. The actuator 27 can move more slowly than might be necessary if the actuator were the same actuator that operated the blade 45, and opening and closing of the flaps can generate less noise than if it were necessary to operate the flaps 23 with the same actuator 47 that moves the blade 45.

The speed of the conveyor 29 is preferably adjustable, preferably upon a signal received from the controller 35. Preferably, the controller 35 is arranged to adjust the speed of the conveyor 29 as a function of a rate at which portions 25 of material to be deposited are received by the one or more flaps 23. For example, the material that is formed into portions 25 may be delivered at a particular rate at a particular temperature but, if the temperature drops or rises, the material is delivered more slowly or faster. If the material is delivered more slowly and, thus, portions 25 are formed more slowly, it may not be possible to deposit portions 25 on all of the desired targets 33 that are conveyed along the conveyor. If the material is delivered more quickly and, thus, portions 25 are formed more quickly, portions may become backed up waiting for targets 33. The controller 35 can send a signal to adjust the speed at which a drive 51 drives the conveyor 29 so that such problems can be avoided.

Also, or alternatively, if desired or necessary, the controller 35 can adjust the speed at which portions 25 are delivered to the flaps 23 can be adjusted, such as by adjusting a speed of a pump 49 that delivers material from the source of supply 39, or close a valve 42v in a conduit 42c leading to the outlet 41. The pump 49 is any suitable pump, such as a screw or vane-type pump. The speed at which the pump 49 delivers material may be adjusted as a function of, for example, the speed at which the conveyor 29 conveys targets 33. By adjusting the speed of the pump 49 so that portions 25 are delivered to the flaps 23 slower or faster, if the material supplied by the pump 49 is less or more difficult to pump, the speed adjustment can keep the delivery of the portions 25 synchonized with the rate at which targets 33 are conveyed by the conveyor 29. If desired or necessary, the depositing system 21 permits adjustment of both the speed of the pump 49 and the speed of the conveyor 29. Similarly, by opening and closing the valve 42v in the conduit 42c to cause there to be a first period during which the valve is open and a second period during which the valve is closed, delivery of portions 25 can be synchronized with the rate at which targets 33 are conveyed. For example, when the flaps 23 open, a switch (not shown) associated with the actuator 27 can generate a signal that is received by the controller 35, and the controller can adjust the pump speed 49 and/or open and close the valve 42v in response to the signal.

In a method for depositing material according to the present invention, a position of a target 33 on a conveyor 29 is sensed by a sensor 31. In response to a signal from the sensor 31, the flaps 23 are moved from a closed position (FIG. 1) in which the flaps are arranged to receive a portion 25 of material to an open position (FIG. 2) in which the flaps permit the portion of material to fall from the flaps so that the portion drops onto the conveyor 29 with a desired spatial relationship to the target 33 on the conveyor, such as directly on the target. Material to be formed into portions 25 is preferably delivered from a source of supply 39 by a pump 49 to a cutting device 43 at which that material is cut into portions of a desired size.

The speed of the conveyor 29 and/or the speed at which portions 25 are delivered to the flaps 23 is adjusted to match the rate at which portions are delivered to the rate at which targets 33 are conveyed.

While this invention has been illustrated and described in accordance with a preferred embodiment, it is recognized that variations and changes may be made therein without departing from the invention as set forth in the claims.

1. A depositing system, comprising:
one or more flaps adapted to move between a closed position in which the one or more flaps is arranged to receive a portion of material to be deposited and an open position in which the one or more flaps permits the portion of material to be deposited to fall from the one or more flaps:
a conveyor;
a sensor adapted to generate a signal upon identification of a target on the conveyor; and
a controller arranged to move the one or more flaps from the closed to the open position in response to the signal so that a portion of material to be deposited drops onto the conveyor with a desired spatial relationship to the target on the conveyor.

2. The depositing system as set forth in claim 1, further comprising a movable blade arrangement for cutting material to be deposited into portions of a desired size, and a delivery apparatus for delivering material to be deposited to the movable blade apparatus.

3. The depositing system as set forth in claim 2, wherein the movable blade arrangement is operated by a first actuating device and the one or more flaps is operated by a second actuating device.

4. The depositing system as set forth in claim 1, wherein the controller is arranged to move the one or more flaps from the closed to the open position in response to the signal so that a portion of material to be deposited drops onto the conveyor on top of the target on the conveyor.

5. The depositing system as set forth in claim 4, wherein the target is separate from the conveyor.

6. The depositing system as set forth in claim 1, wherein a speed of the conveyor is adjustable.

7. The depositing system as set forth in claim 6, wherein the controller is arranged to adjust the speed of the conveyor.

8. The depositing system as set forth in claim 7, wherein the controller is arranged to adjust the speed of the conveyor as a function of a rate at which portions of material to be deposited are received by the one or more flaps.

9. The depositing system as set forth in claim 1, further comprising a source of supply of material for forming portions to be deposited and a pump for delivering the material from the source of supply to the flaps, wherein a speed of the pump is adjustable.

10. The depositing system as set forth in claim 9, wherein the speed of the pump is adjustable as a function of a rate at which the conveyor conveys targets.

11. A method for depositing material, comprising:
sensing a position of a target on a conveyor with a sensor; and
in response to a signal from the sensor, moving one or more flaps from a closed position in which the one or more flaps is arranged to receive a portion of material to be deposited to an open position in which the one or more flaps permits the portion of material to be deposited to fall from the one or more flaps so that the portion of material to be deposited drops onto the conveyor with a desired spatial relationship to the target on the conveyor.

12. The method for depositing material as set forth in claim 11, further comprising delivering material to be deposited to a cutting device and cutting material to be deposited into portions of a desired size with the cutting device.

13. The method for depositing material as set forth in claim 12, comprising operating the cutting device with a first actuating device and operating the one or more flaps with a second actuating device.

14. The method for depositing material as set forth in claim 11, comprising moving the one or more flaps from the closed to the open position so that a portion of material to be deposited drops onto the target on the conveyor.

15. The method for depositing material as set forth in claim 14, wherein the target is separate from the conveyor.

16. The method for depositing material as set forth in claim 11, comprising adjusting a speed of the conveyor.

17. The method for depositing material as set forth in claim 16, wherein the speed of the conveyor is adjusted as a function of a rate at which portions of material to be deposited are received by the one or more flaps.

18. The method for depositing material as set forth in claim 11, further comprising supplying portions to be deposited to the flaps and adjusting a rate at which portions are supplied to the flaps.

19. The method for depositing material as set forth in claim 18, comprising adjusting the rate at which portions are supplied to the flaps as a function of a rate at which the conveyor conveys targets.

20. The method for depositing material as set forth in claim 18, comprising adjusting the rate at which portions are supplied to the flaps by adjusting a speed of a pump for delivering material to be deposited.

21. The method for depositing material as set forth in claim 18, comprising adjusting the rate at which portions are supplied to the flaps by adjusting periods during which a valve in a conduit for delivering material to be deposited is opened and closed.

22. An assembly line, comprising:
a conveyor for conveying targets;
a sensor adapted to generate a signal upon sensing a location of a target on the conveyor;
a door above the conveyor, the door being movable between a closed position and an open position; and
a controller arranged to open the door in response to the signal from the sensor.
